(19) United States
(12) Patent Application Publication
(10) Pub. No.: US 2012/0089646 A1
(43) Pub. Date: Apr. 12, 2012

(54) PROCESSING CHANGE DATA

(76) Inventors: Rohit N. Jain, Austin, TX (US); Yuval Sherman, Haifa (IL); Gary S. Smith, Auburn, CA (US)

(21) Appl. No.: 12/901,156

(22) Filed: Oct. 8, 2010

(51) Int. Cl. G06F 17/30

(52) U.S. Cl. 707/792; 707/E17.055

(57) ABSTRACT

A method of performing a database join is provided herein. The method includes receiving a query. The query may specify an update for a table. The method further includes determining that the table is associated with a subscriber. Additionally, the method includes generating an audit log for the update within the table. The audit log may comprise the update.

### BACKGROUND

Both materialized views and change data capture applications may access data that has changed in database tables. The changes may result from the insert, delete, and update operations applied to the database. Data that has changed is referred to herein as “change data.” Typical solutions for access may involve database management systems (DBMSs) capturing change data in logs, such as audit logs that can be mined for change data.

These solutions may severely impact the load/update processing for data warehouses. Additionally, these solutions may not scale well when very large volumes of updates are applied to the data warehouse, especially where the changed data only involves a small proportion of tables in the database.

Further, in some cases, it may be useful to make the change data accessible to other applications instantly. In the case of an active-active Disaster Recovery replication application, queries to the live production database and the disaster recovery back-up may be configured to provide the same up-to-the-second results for queries. Such applications may have little tolerance for latency. Latency may also hinder the performance of real-time, streamed, event applications, such as Complex Event Processing applications.

Current solutions for change data capture and materialized view updates are computationally expensive. An improved method for performing change data capture and materialized view updates would be useful.

### BRIEF DESCRIPTION OF THE DRAWINGS

Certain embodiments are described in the following detailed description and in reference to the drawings, in which:

FIG. 1 is a block diagram of a data warehouse system in accordance with an example embodiment of the invention;

FIG. 2 is a block diagram of a system for change data capture in accordance with an example embodiment of the invention;

FIG. 3 is a process flow diagram of a method for processing change data in accordance with an example embodiment of the invention;

FIG. 4 is a process flow diagram of a method for retrieving incremental updates in accordance with an example embodiment of the invention;

FIG. 5 is a block diagram of a system for processing change data according to an example embodiment of the invention; and

FIG. 6 is a block diagram showing a non-transitory, computer-readable medium that stores code for processing change data.

### DETAILED DESCRIPTION

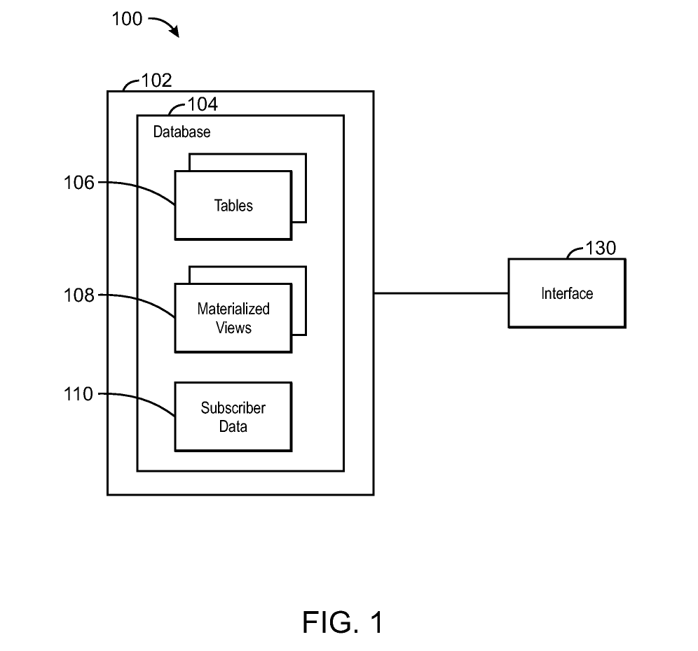

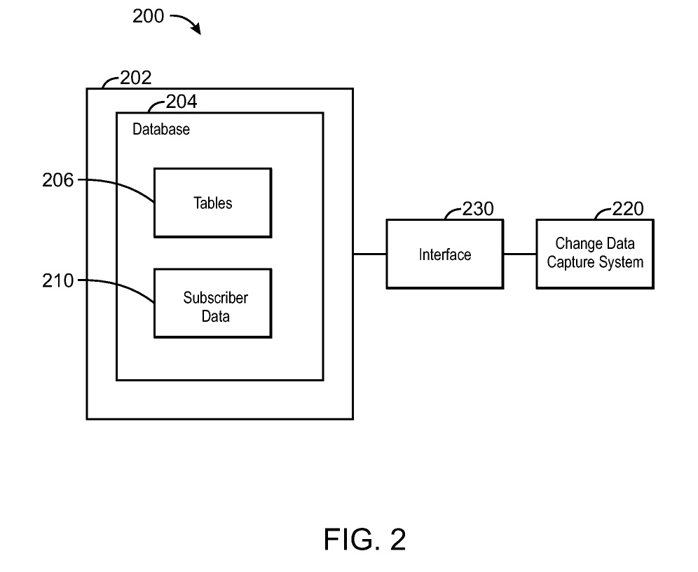

In data warehouse systems, there are areas of functionality that may be configured to process change data. Two of these areas are materialized views and change data capture (CDC). Materialized views (views) and change data capture are described in greater detail with respect to FIGS. 1 and 2, respectively.

FIG. 1 is a block diagram of a data warehouse system 100 in accordance with an example embodiment of the invention. The data warehouse system 100 may include a data warehouse 102 and an interface 130. The data warehouse 102 may be a repository of data resources, configured to facilitate reporting and analysis.

The data warehouse 102 may include a database 104, which may include tables 106, materialized views (views) 108, and subscriber data 110. The views 108 may store results from join and aggregation queries against selected tables 106.

Because the results may be stored in the views 108, a user may simply run a query against the views 108, instead of executing computationally expensive joins and aggregations against multiple tables 106. As such, results stored in the view 108 can be provided to end users without expending resources redundantly at run-time.

Updates to the tables 106 may impact the accuracy of the views 108. As such, the views 108 may be periodically refreshed by re-executing corresponding join or aggregation queries. It should be noted that the term “update” is used herein to generically refer to INSERT, DELETE, UPDATE (IUD) operations against the tables 106.

While the tables 106 in the data warehouse 202 may be large, updates to the tables 106 may be infrequent. For example, in one scenario, the tables 106 may include a year's worth of data. However, only about 0.3% of the data may be updated on a daily basis.

When used to refresh views 108, join and aggregation queries may scan entire tables. As such, refreshing the views 108 by re-executing join or aggregation queries may be computationally expensive, especially in light of the percentage of data that is updated.

Typically, specified processes refresh views 108. In one embodiment of the invention, these processes may subscribe to the tables 106 used to refresh the views 108. In such an embodiment, incremental updates may be retrieved from the table and applied to the view 108, instead of re-executing a join or aggregation query.

In one embodiment of the invention, the incremental update may be a row stored in the table 106 that captures a change to the table. Advantageously, retrieving and applying incremental updates to the views 108 may be more efficient than re-executing a join or aggregation query, even if the percentage of rows being updated is significant.

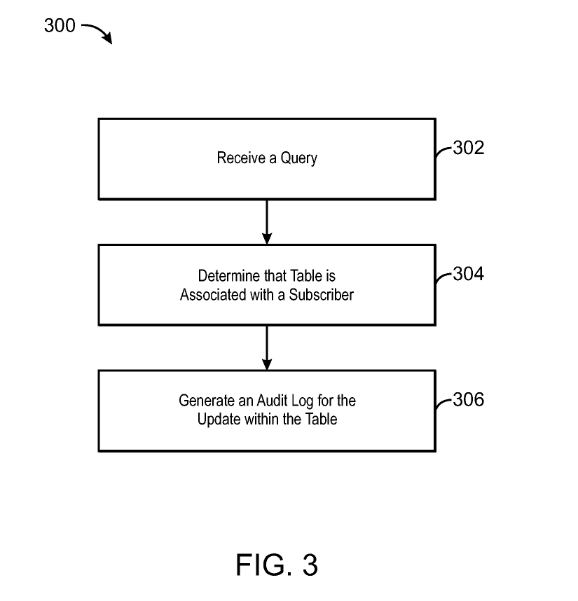

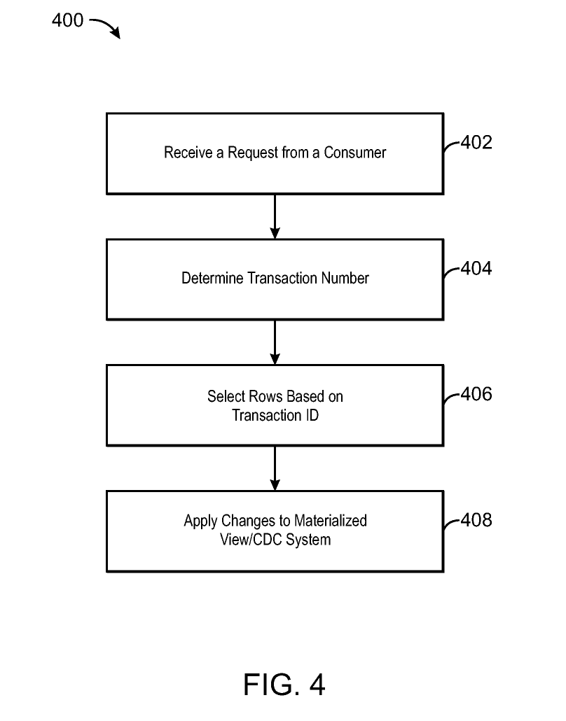

The subscriber data 110 may identify subscribers, and enable the identification of incremental updates for updating the views 108. Subscriber may be processes that use change data. For example, subscribers may include processes, such as fraud detection or other CEP/analytics queries. Subscribers may also include processes that update materialized views. The subscriber data 110 is described in greater detail with reference to FIGS. 3-4.

FIG. 2 is a block diagram of a system 200 for change data capture in accordance with an example embodiment of the invention. The system 200 may include a source system 202, an interface 230, and a change data capture system 220.

The change data capture system 220 may include numerous applications, ranging from partial to full replication of data in the source system 202. Partial replication may be used to update data warehouses or data marts. Full replication may be used to facilitate applications such as Disaster Recovery.

Other technologies may make use of the change data capture system 220, such as data integration tools and event-based processing. Data integration tools may leverage the change data capture system 220 to facilitate data provisioning in enterprise applications.

In event-based processing, such as complex event processing (CEP), specified updates to the database may represent events. The occurrence of an event may be published to inform decision making. In some scenarios, an event may trigger automated responses. The change data capture system 220 may enable the publishing of such events, and the initiation of automated responses.

The change data capture system 220 may also subscribe to the tables 206. Through the interface 230, the change data capture system 220 may retrieve incremental updates to the database 204. Similar to the subscriber data 110, the subscriber data 210 may be used to identify incremental updates to subscribers, such as the change data capture system 220.

FIG. 3 is a process flow diagram of a method 300 for processing change data in accordance with an example embodiment of the invention. It should be understood that the process flow diagram is not intended to indicate a particular order of execution. The method 300 may be performed by a database execution engine.

The method 300 begins at block 302, where a query is received. The query may specify an update to a database table. For example, the following query specifies an address update in a TABLE 1.

### UPDATE TABLE 1 SET ADDRESS=‘123 COOK ST.’ WHERE CUST=‘00001’

### QUERY 1

At block 304, the database execution engine may determine that the database table is associated with a subscriber. In one embodiment of the invention, the subscriber data 110, 210 may identify all tables 106, 206 with subscribers.

At block 306, the database execution engine may generate a new row in the table that includes the update specified in the query. The new row may represent an incremental update. For example, given a table:

TABLE 1

| CUST | ADDRESS | CITY |
|---|---|---|
| 00001 | 200 MAIN ST. | CHICAGO |
| 00002 | 1921 FORD AVE. | DETROIT |

An update such as that specified in QUERY 1, may result in the following change:

TABLE 1

| CUST | ADDRESS | CITY |
|---|---|---|
| 00001 | 200 MAIN ST. | CHICAGO |
| 00001 | 123 COOK ST. | CHICAGO |
| 00002 | 1921 FORD AVE. | DETROIT |

In one embodiment of the invention, the tables 106 may include an additional column that identifies the incremental update. For example, the transaction number of the query that inserts the row may be included. In such an embodiment, the following table may result from the execution of QUERY 1:

TABLE 1

| CUST | ADDRESS | CITY | TRANSACTION |
|---|---|---|---|
| 00001 | 200 MAIN ST. | CHICAGO | 100000 |
| 00001 | 123 COOK ST. | CHICAGO | 123456 |
| 00002 | 1921 FORD AVE. | DETROIT | 112222 |

Where TRANSACTIONS 100000, 123456, and 112222 each represent the transaction identifier of the queries that created the respective rows. As understood by one skilled in the art, the transaction identifier is a number assigned by the database management system to each query. The table may also include a timestamp column. The timestamp column may serialize updates when a single transaction updates more than one row.

In another embodiment of the invention, the tables 106 may include a column indicating whether a particular row is obsolete. For example, the new row generated at block 306 now contains the current ADDRESS for CUST ‘00001.’ As such, for the first row, the OBSOLETE may be set, indicating the row is obsolete in light of the update. For example, the following table may result:

TABLE 1

| CUST | ADDRESS | CITY | OBSOLETE |
|---|---|---|---|
| 00001 | 200 MAIN ST. | CHICAGO | Y |
| 00001 | 123 COOK ST. | CHICAGO | N |
| 00002 | 1921 FORD AVE. | DETROIT | N |

In some cases, the query may specify that a row be deleted, such as:

### DELETE FROM TABLE 1 WHERE CUST=‘00002’

### QUERY 2

In such a case, the OBSOLETE column may be set. For example, the following TABLE 1 may result from QUERY 2:

TABLE 1

| CUST | ADDRESS | CITY | OBSOLETE |
|---|---|---|---|
| 00001 | 200 MAIN ST. | CHICAGO | Y |
| 00001 | 123 COOK ST. | CHICAGO | N |
| 00002 | 1921 FORD AVE. | DETROIT | Y |

Because the subscribed-to tables may contain additional rows for each incremental update, results from other queries may be affected. As such, the OBSOLETE column may be used by the database execution engine to distinguish the incremental updates from current data. In one embodiment of the invention, the database engine may hide the transaction and obsolete columns. The database engine may restrict querying against these columns to subscribers.

More specifically, a query that performs a selection against TABLE 1, updated as described above, may be augmented with a selection predicate using the OBSOLETE column. For example, a selection query, such as:

### SELECT * FROM TABLE 1

### QUERY 3

may be augmented to only select rows with current data, as follows:

### SELECT * FROM TABLE 1 WHERE OBSOLETE=‘N’

### QUERY 4

Once the incremental updates are stored in the updated tables 106, subscribers may retrieve and apply the updates to materialized views 108 or the change data capture system 220.

It should be noted that QUERIES 2-4 are used merely for purposes of clarity. QUERIES 2-4 should not be confused with transactional locking semantics, e.g., repeatable reads, read committed/uncommitted. Serialization rules for ACID compliance may still be enforced. The ACID compliance may be independent of the subscriber semantics.

FIG. 4 is a process flow diagram of a method 400 for retrieving incremental updates in accordance with an example embodiment of the invention. It should be understood that the process flow diagram is not intended to indicate a particular order of execution. The method 400 may be performed by the interface 130, 230.

The method 400 begins at block 402, where a request from a subscriber may be received. The request may specify tables from which incremental updates are to be retrieved.

At block 404, the interface 130, 230 may determine the transaction number of the last retrieved update. In one embodiment of the invention, the request may specify the transaction number or the timestamp of the last incremental update retrieved by this subscriber. In another embodiment of the invention, the subscriber data 110, 210 may include the transaction number of the last incremental update retrieved for each subscriber.

At block 406, the interface 130, 230 may select rows from the subscribed-to tables based on the determined transaction number. As understood by one skilled in the art, the transaction number of any particular query is greater than a previously executing query. As such, once a subscriber has retrieved an incremental update, subsequent updates may be identified because the transaction numbers will be greater than the transaction number of the most recently retrieved update.

At block 408, the subscriber may apply the incremental updates to the views 108 or the change data capture system 220.

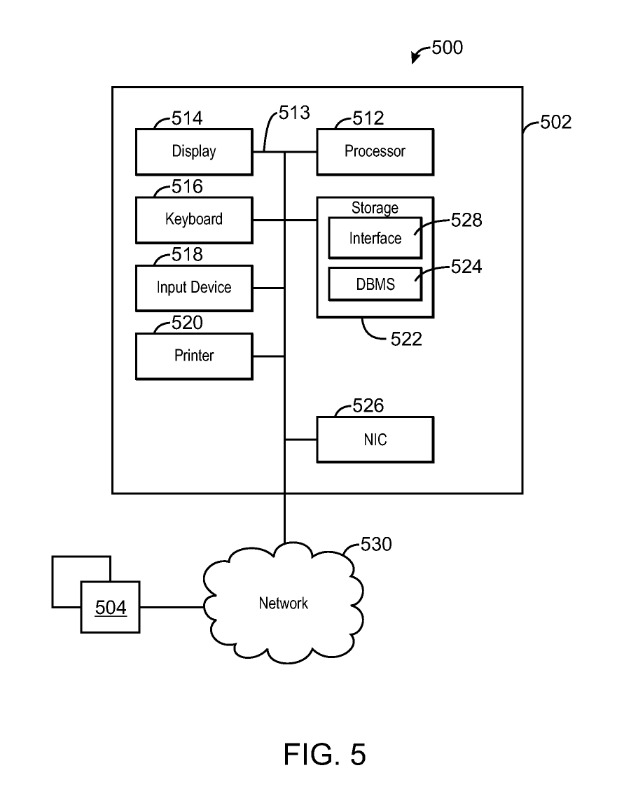

FIG. 5 is a block diagram of a system 500 for processing change data according to an example embodiment of the invention. The system is generally referred to by the reference number 500. Those of ordinary skill in the art will appreciate that the functional blocks and devices shown in FIG. 5 may comprise hardware elements, software elements, or some combination of software and hardware. The hardware elements may include circuitry. The software elements may include computer code stored on a non-transitory, computer-readable medium.

Additionally, the functional blocks and devices of the system 500 are but one example of functional blocks and devices that may be implemented in an embodiment of the invention. Those of ordinary skill in the art would readily be able to define specific functional blocks based on design considerations for a particular electronic device.

The system 500 may include servers 502, 504, in communication over a network 530. The server 504 may be similarly configured to the server 502.

As shown, the server 502 may include one or more processors 512, which may be connected through a bus 513 to a display 514, a keyboard 516, one or more input devices 518, and an output device, such as a printer 520. The input devices 518 may include devices such as a mouse or touch screen.

The server 502 may also be connected through the bus 513 to a network interface card 526. The network interface card 526 may connect the database server 502 to the network 530.

The network 530 may be a local area network, a wide area network, such as the Internet, or another network configuration. The network 530 may include routers, switches, modems, or any other kind of interface device used for interconnection. In one embodiment of the invention, the network 530 may be the Internet.

The server 502 may have other units operatively coupled to the processor 512 through the bus 513. These units may include non-transitory, computer-readable storage media, such as storage 522.

The storage 522 may include media for the long-term storage of operating software and data, such as hard drives. The storage 522 may also include other types of non-transitory, computer-readable media, such as read-only memory and random access memory.

The storage 522 may include the software used in embodiments of the present techniques. In an embodiment of the invention, the storage 522 may include a database management system (DBMS) 524 and an interface 528. The database management system 524 may generate incremental updates for subscribers in tables of the DBMS 524. The interface 528 may retrieve the incremental updates for the subscribers to apply to the views 108 or the change data capture systems 220.

Once all subscribers have retrieved the incremental updates for a particular table, the DBMS 524 may delete all the obsolete rows from that table. In one embodiment of the invention, the DBMS 524 may perform clean-up processes on the subscribed-to tables.

In a massively parallel processing system, the tables of the DBMS 524 may be partitioned across numerous storage devices. As such, embodiments of the invention may provide scalability for Enterprise Data Warehouse environments, and change data capture systems 200 with large volumes of data.

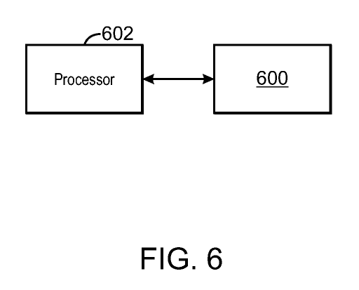

FIG. 6 is a block diagram showing a non-transitory, computer-readable medium 600 that stores code for processing change data. The non-transitory, computer-readable medium 600 may correspond to any typical storage device that stores computer-implemented instructions, such as programming code or the like. For example, the non-transitory, computer-readable medium 600 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 602 generally retrieves and executes the computer-implemented instructions stored in the non-transitory, computer-readable medium 600 to generate incremental updates. A query may be received. The query may be determined to be updating a table associated with a subscriber. A new row may be generated for the table comprising the update.

What is claimed is:

1. A method of processing change data, comprising:
receiving a query that specifies an update for a table;
determining that the table is associated with a subscriber; and
generating an audit log for the update within the table, wherein the audit log comprises the update.

2. The method recited in claim 1, wherein generating the audit log comprises inserting a first row into the table, wherein the first row comprises:
a transaction identifier for the query, wherein the transaction identifier is generated by a database management system executing the query;
a timestamp for the update; and
an obsolete indicator, wherein the obsolete indicator is set if the row is obsolete.

3. The method recited in claim 2, further comprising:
retrieving a second row associated with the update; and
setting the obsolete indicator.

4. The method recited in claim 3, comprising:
receiving a request from the subscriber;
determining a previous transaction identifier for the subscriber;
retrieving the first row from the table based on the previous transaction identifier; and
retrieving the second row from the table based on the previous transaction identifier.

5. The method recited in claim 4, comprising applying a change to a materialized view associated with the table, based on the first row.

6. The method recited in claim 4, comprising a change data capture system processing the first row.

7. The method recited in claim 6, wherein the change data capture system comprises at least one of the following:
a replication system;
a data warehouse;
a disaster recovery system;
a complex event processing system;
provisioning by a data integration tool; or
combinations thereof.

8. The method recited in claim 4, wherein the table is a relational database table partitioned across a plurality of storage devices, and comprising selecting a plurality of rows from the table in parallel processes.

9. The method recited in claim 1, wherein determining that the table is associated with a subscriber comprises performing a look-up in a table comprising a column associated with the table.

10. A computer system for processing change data, comprising:
a memory; and
a processor, configured to:
receive a query that specifies an update for a table;
determine that the table is associated with a subscriber;
generate an audit log for the update within the table, wherein the audit log comprises the update;
retrieve the audit log; and
apply the update to a materialized view.

11. The computer system recited in claim 10, wherein generating the audit log comprises inserting a first row into the table, wherein the first row comprises:
a transaction identifier for the query, wherein the transaction identifier is generated by a database management system executing the query;
a timestamp for the update; and
an obsolete indicator, wherein the obsolete indicator is set if the row is obsolete.

12. The computer system recited in claim 10, wherein generating the audit log comprises:
retrieving a second row associated with the update; and
setting the obsolete indicator.

13. The computer system recited in claim 10, wherein retrieving the audit log comprises:
receiving a request from the subscriber;
determining a previous transaction identifier for the subscriber;
retrieving the first row from the table based on the previous transaction identifier; and
retrieving the second row from the table based on the previous transaction identifier.

14. The computer system recited in claim 10, wherein the processor is configured to process the first row using a change data capture system.

15. The computer system recited in claim 10, wherein the table is a relational database table partitioned across a plurality of storage devices, and wherein the processor is configured to select a plurality of rows from the table in parallel processes.

16. The computer system recited in claim 10, wherein determining that the table is associated with a subscriber comprises performing a look-up in a table comprising:
a column associated with the subscriber; and
a column associated with the table.

17. A non-transitory, computer-readable medium comprising machine-readable instructions executable by a processor to process change data, wherein the machine-readable instructions, when executed by the processor, cause the processor to:
receive a query that specifies an update for a table;
determine that the table is associated with a subscriber; and
generate an audit log for the update within the table, wherein generating the audit log comprises inserting a first row into the table, wherein the first row comprises a timestamp for the query;

18. The non-transitory, computer-readable medium recited in claim 17, comprising machine-readable instructions which, when executed by the processor, cause the processor to:
retrieve a second row associated with the update; and
set an obsolete indicator for the second row.

19. The non-transitory, computer-readable medium recited in claim 17, comprising machine-readable instructions which, when executed by the processor, cause the processor to:
receive a request from the subscriber; and
retrieve the first row from the table based on the request and the timestamp.

20. The non-transitory, computer-readable medium recited in claim 17, comprising machine-readable instructions which, when executed by the processor, cause the processor to apply a change to a materialized view associated with the table, based on the first row.
